(19) United States
(12) Patent Application Publication
(10) Pub. No.: US 2012/0052698 A1
(43) Pub. Date: Mar. 1, 2012

(54) RECEPTACLE CONNECTOR

(75) Inventor: KEQI SHU, Dong-Guan (CN)

(73) Assignee: Cheng Uei Precision Industry Co., LTD., Tu-Cheng City (TW)

(21) Appl. No.: 12/871,673

(22) Filed: Aug. 30, 2010

(51) Int. Cl. H01R 12/14

(52) U.S. Cl. 439/55

(57) ABSTRACT

A receptacle connector soldered on a print circuit board includes an insulating housing having a plurality of terminals fixed within. A main shell encircling the insulating housing therein has a top plate, a bottom plate and two opposite side plates. The side plate is of substantially continuous structure. An auxiliary shell fixedly attached on the top plate of main shell has two first soldering feet extended at two opposite sides thereof to beyond the corresponding side plates for being soldered on the print circuit board. Such design could improve the strength of the main shell and avoid the deformation of the main shell when a complementary connector is inserted into the receiving room with excessively insertion force.

### BACKGROUND OF THE INVENTION

1. Field of the Invention

The present invention relates to a receptacle connector, and more particularly to a receptacle connector capable of connecting with a complementary connector smoothly and exactly.

2. The Related Art

Nowadays, with the development of the technology of the electrons, the electronic products and the devices around the electronic products connect more and more frequently. One of the main styles is though two mated receptacle connectors to realize connection between the electronic products and the devices around the electronic products. Naturally, the receptacle connector is used more and more frequently. The receptacle connector is used in electronics industry so widely and frequently that the user more and more pays attention to the quality of the receptacle connector. In order to meet the requirement of using the receptacle connector, factories need to improve the quality of the receptacle connector and let the receptacle connector connect with a complementary connector firmly.

Please refer to FIG. 1 and FIG. 2, a conventional receptacle connector comprises a shell 110, an insulating housing 120, and a plurality of terminals 130. The shell 110 comprises a top plate 111, a bottom plate 112, and two opposite side plates 113 connecting the top plate 111 with the bottom plate 112. The top plate 111, the bottom plate 112 and two side plates 113 collectively define a receiving room 114 for containing the insulating housing 120. Each side plate 113 respectively has two soldering feet 116. One soldering foot 116 is disposed at a middle portion of the side plate 113, and the other soldering foot 116 extends from a rear edge of the side plate 113. The soldering foot 116 located at the middle portion of the side plate 113 is formed by means of cutting the side plate 113, and therefore an opening 117 is formed at the middle portion of the side plate 113. The insulating housing 120 comprises a base portion 121 and a tongue portion 122 extended from the base portion 121. The base portion 121 defines two rows of terminal grooves 123 running along front-to-rear direction and extending to a free end of the tongue portion 122 for receiving the terminals 130. In assembly, the terminals 130 are fixed in the insulating housing 120. The insulating housing 120 with the terminals 130 fixed therein is received in the receiving room 114.

However, when a complementary connector (not shown) is inserted into the receptacle connector slantingly, a front end of the complementary connector would get stick in the opening 117. In other words, the whole complementary connector would be blocked by the opening 117 that leads the complementary connector to disconnect with the receptacle connector properly. If the user continually inserts the complementary connector when the front end of the complementary connector is stuck in the opening 117, the shell 110 would be deformed and even damaged. As a result, the working life of the receptacle connector and the complementary connector would be greatly shortened.

### SUMMARY OF THE INVENTION

It is an object of the present invention to provide a receptacle connector capable of connecting with a complementary connector smoothly and exactly. The receptacle connector soldered on a print circuit board includes an insulating housing having a plurality of terminals received therein. A main shell encircling the insulating housing therein has a top plate, a bottom plate and two opposite side plates. The side plate is of substantially continuous structure. An auxiliary shell fixedly attached on the top plate of main shell has two first soldering feet extended at two opposite sides thereof to beyond the corresponding side plates for being soldered on the print circuit board.

As described above, the receptacle connector further comprises the auxiliary shell soldered on the top plate of the main shell, which has two first soldering feet instead of the corresponding soldering feet on the side plate as case shown in the prior art. So the side plate is of continuous structure. Furthermore, such design could improve the strength of the main shell and avoid the deformation of the main shell when the complementary connector is inserted into the receiving room with excessively insertion force.

### BRIEF DESCRIPTION OF THE DRAWINGS

The present invention will be apparent to those skilled in the art by reading the following description, with reference to the attached drawings, in which:

FIG. 1 is a perspective view of a receptacle connector in accordance with the prior art;

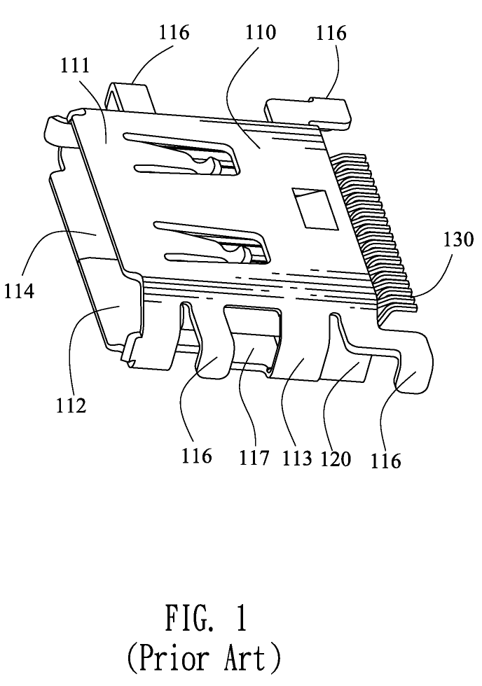

FIG. 2 is an exploded view of the receptacle connector shown in FIG. 1;

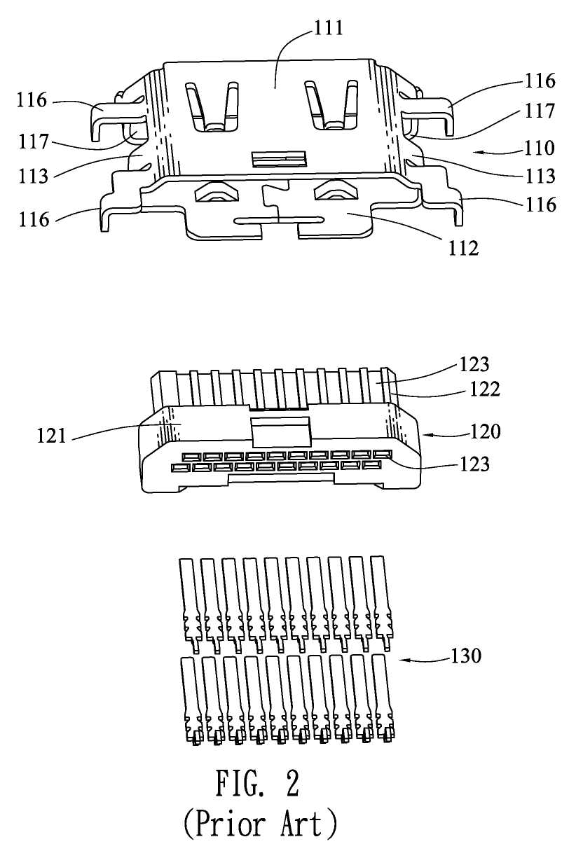

FIG. 3 is a perspective view of a receptacle connector in accordance with an embodiment of the present invention;

FIG. 4 is an exploded view of the receptacle connector shown in FIG. 3;

FIG. 5 is another exploded view of the receptacle connector shown in FIG. 3;

### DETAILED DESCRIPTION OF THE PREFERRED EMBODIMENT

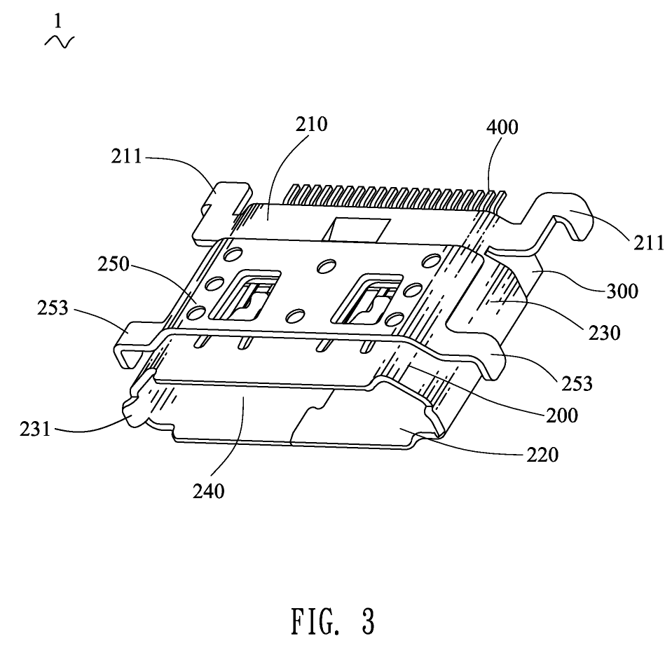

With reference to FIG. 3, a receptacle connector 1 according to the invention is shown. The receptacle connector 1 includes an insulating housing 300, a main shell 200, an auxiliary shell 250, a plurality of terminals 400.

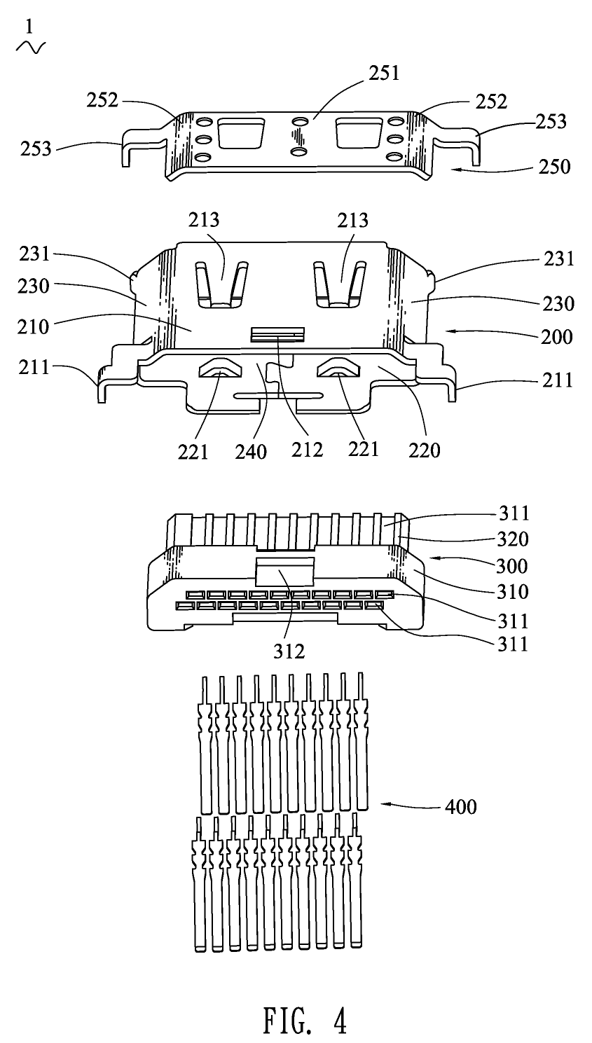

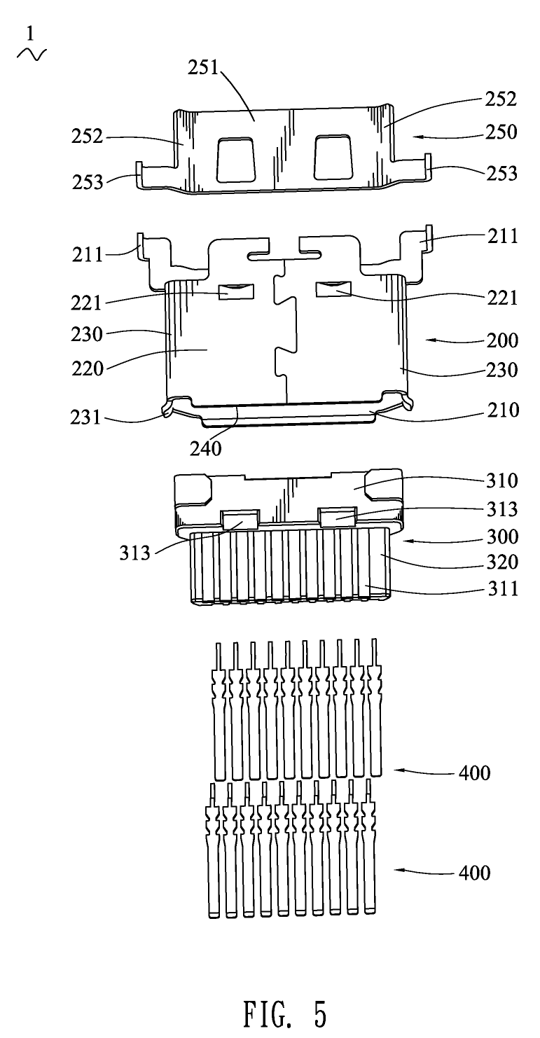

Please refer to FIGS. 4 to FIGS. 5. The insulating housing 300 has a substantially rectangular base portion 310 and a tongue portion 320 extended forwards from the base portion 310. The base portion 310 defines two rows of terminal grooves 311 extended in a front-to-rear direction for receiving the terminals 400. The terminal grooves 311 respectively extend to a free end of the tongue portion 320. The base portion 310 defines a recess 312 disposed at a middle of a rear of a top surface thereof and two fixing recesses 313 disposed at a front end of a bottom surface thereof.

Please refer to FIG. 4 and FIG. 5 together. The main shell 200 comprises a top plate 210, a bottom plate 220, and two opposite side plates 230 connecting the top plate 210 with the bottom plate 220. The top plate 210, the bottom plate 220 and two side plates 230 collectively define a receiving room 240 for containing the insulating housing 300. Each side plate 230 has a guiding portion 231 extending outward from a front end thereof. The top plate 210 has two second soldering feet 211 extended rearwards and bent downwards from two opposite rear ends thereof. The side plate 230 is of substantially continuous structure in the front and rear direction, which makes sure a complementary connector (not shown) be inserted into the receptacle connector 1 smoothly. A rear portion of the top plate 210 is punched inward to form a buckling piece 212 for being received in the recess 312. Two resilient pieces 213 are formed at a middle portion of the top plate 210 of the main shell 200. The complementary connector can electrically connect with the receptacle connector 1 exactly and firmly with the help of the resilient pieces 213. A rear portion of the bottom plate 220 is punched inward to form two projections 221 for being received in the fixing recess 313.

Please refer to FIG. 4 and FIG. 5 together. The auxiliary shell 250 has a substantially rectangular base plate 251. Two opposite side edges of the base plate 251 respectively slants downwards to form a matching plate 252 which is capable of matching with side plate 230 compactly. A front portion of an outer side edge of the matching plate 252 extends outward and bends downward to form an inverted-L shaped first soldering foot 253. The auxiliary shell 250 is fixedly attached on the top plate 210 of the main shell 200 by means of soldering and a front edge of the base plate 251 is in alignment with a front edge of the top plate 210. Such integrated structure of the auxiliary shell 250 and the main shell 200 can further improve the strength of the main shell 210.

Referring to FIG. 4 and FIG. 5, in assembly, the terminals 400 is fixed in the terminal grooves 311 of the insulating housing 300. The insulating housing 300 is received in the receiving room 240 of the main shell 200, the buckling piece 212 is mounted in the recess 312, and the projection 221 is mounted in the fixing recess 313. The auxiliary shell 250 is fixedly attached on the top plate 210 by means of soldering and the first soldering feet 253 stretch outside of the side plates 230. The receptacle connector 1 is mounted on a print circuit board (not shown), and both the first soldering feet 253 and the second soldering feet 211 are soldered with the corresponding soldering points disposed at the print circuit board.

When the complementary connector is inserted into the receptacle connector 1, the complementary connector can be inserted into the receiving room 240 smoothly and connected with the receptacle connector 1 exactly as the guiding portion 231 has guiding function and the side plate 230 is of continuous structure.

As the above description, the receptacle connector 1 further comprises the auxiliary shell 250 soldered on the top plate 210 of the main shell 200, which has two first soldering feet 253 instead of the corresponding soldering feet on the side plate as case shown in the prior art. So the side plate 230 is of continuous structure. Furthermore, such design could improve the strength of the main shell 200 and avoid the deformation of the main shell 200 when the complementary connector is inserted into the receiving room 240 with excessively insertion force.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A receptacle connector soldered on a print circuit board, comprising:
an insulating housing;
a plurality of terminals fixed in the insulating housing;
a main shell encircling the insulating housing therein, the main shell including a top plate, a bottom plate and two opposite side plates, the side plate being of substantially continuous structure; and
an auxiliary shell fixedly attached on the top plate of main shell, the auxiliary shell having two first soldering feet extended at two opposite sides thereof to beyond the corresponding side plates for being soldered on the print circuit board.

2. The receptacle connector as claimed in claim 1, wherein the auxiliary shell has a base plate and two matching plates extended outwards from two opposite side edges of the base plate for being matched with upper portions of the corresponding side plates of the main shell.

3. The receptacle connector as claimed in claim 2, wherein the first soldering foot is extended at a portion of an outer side edge of the matching plate.

4. The receptacle connector as claimed in claim 1, wherein the top plate has two second soldering feet extended at two opposite rear edges thereof and spaced from the first soldering feet.

5. The receptacle connector as claimed in claim 1, wherein the auxiliary shell is soldered on the top plate of the main shell.
